(19) United States
(12) Patent Application Publication
(10) Pub. No.: US 2007/0102673 A1
(43) Pub. Date: May 10, 2007

(54) Composite structure

(76) Inventors: James Robert Durrant, London (GB); Saif Ahmed Maque, Northwood (GB); Andrew Bruce Holmes, Parkville (AU); Talno Park, Urbana, IL (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/551,928

(22) PCT Filed: Apr. 2, 2004
(86) PCT No.: PCT/GB04/01467

§ 371 Date: Oct. 24, 2006

(30) Foreign Application Priority Data
Apr. 5, 2003 (GB) 0307975.3

(51) Int. Cl. H01B 1/12

(52) U.S. Cl. 252/500

(57) ABSTRACT

A composite structure comprises a dual-function material intermediate a conducting material and a semiconductor. The dual-function material comprises an organic material and at least one ionic species such that the organic material has both electronic charge transport properties and supports or chelates the at least one ionic species. The conducting material comprises an ohmic conductor, a semiconducting material or an ionic conductor. The composite structures are suitable for use in electrochemical devices such as photo-voltaic cells, photodiodes, batteries, electrodes, electrochromic devices and light-emitting diodes.

This invention relates to composite structures, in particular to composite structures containing conductive organic species.

Composite structures are known, for example in the formation of electrochemical devices such as solar cells. A particular example of a thin-film solar cell application is the dye-sensitised cell developed by Grätzel et al. (Nature, 1991, 353, 737), where a high-surface area, dye-coated semiconducting working electrode is in contact with a charge-carrying, mobile redox couple or hole-transporting material (htm). The action of the redox couple or htm is to complete the charge transfer process by injecting an electron into the photo-oxidised dye to restore it to the ground-state. In early work, cells were made with the redox couple dissolved in a liquid electrolyte. More recently, increasing efforts have been made to find solid-electrolyte alternatives, for example by incorporating gelling agents or organic polymers (Grätzel et al. Nature, 1998, 395, 583).

To improve the amorphous character, and hence conductivity, transparency etc., of these types of materials, spiro versions of triarylamines have been developed e.g. spirobifluorene triarylamine derivatives (U. Bach et al., Adv. Mater., 2000, 12, 1060; Kruger, et al., Adv. Mater., 2000, 12, 447). Furthermore, triarylamine materials incorporating ion-chelating structures have been found to function as hole-transporting materials in Grätzel-type cells (WO 02/051958).

In Grätzel-type cells, a mobile ionic species needs to be added to the organic htm in order to balance the electronic charge generated on illumination of the semiconductor. Normally, a lithium salt in a pyridine-based solvent is used as the ionic species (Grätzel et al. Nature, 1998, 395, 583). Such solutions of salts can be hazardous, and being mobile, volatile phases, they are problematic to contain within the cell. A typical quasi solid-state version of the Grätzel cell thus comprises a dye-sensitised titania layer, coated with a mixture of a hole-conducting spiro polymer blended with a lithium salt and tert-butyl pyridine. The two outer surfaces of the cell usually carry a conducting metallic or oxide layer to extract current from the cell. It is possible to omit the mobile ions, however, this severely limits the cell efficiency.

The present applicants have found that by confining an ionic species to the interfacial region between a conducting electrode and a conducting polymer, the problems associated with the use of a mobile species can be mitigated.

In accordance with a first aspect of the present invention, a composite structure comprises a dual-function material intermediate a conducting material and a semiconductor; wherein the conducting material comprises an ohmic conductor, a semiconducting material or an ionic conductor and wherein the dual-function material comprises an organic material and at least one ionic species, said organic material comprising at least one moiety represented by the general formula (I):
[Y]—X (I)

wherein [Y] comprises an organic semiconductor; and wherein X comprises an ion-chelating group, said organic material having both electronic charge transport properties and supporting or chelating the at least one ionic species.

The present invention provides a significant advantage over for example, the Grätzel type cell, in that the dual-function material effectively confines an ionic species at its interface with a semiconductor, facilitating charge transfer at this interface. Problems associated with leakage and migration of liquid phase, such as a solution of a lithium salt are avoided.

The ionisation potential and/or the electron affinity of the organic constituent of the dual-function material should be such that it favours ordering of the ionisation potential and/or electron affinity relative to the semiconductor, enabling charge separation across the interface. The dual-function material may also serve to reduce any interfacial energetic mismatch between the conducting material and the semiconductor.

The organic material comprises an organic semiconductor [Y]; and an ion-chelating group X, wherein groups [Y] and X are covalently linked together either directly or via a linker group.

The present applicants have discovered a novel class of hole conducting polymers, which can also display electronic conduction properties. These polymers, which are based on tri-aryl amine moieties, are detailed in WO 02/051958 and comprise ion-chelating side-chains which can support or chelate ionic species, thus providing the required ionic component. Thus in a preferred embodiment, [Y] comprises a moiety represented by the general formula (II): 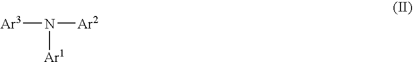
wherein Ar¹, Ar² and Ar3 are independently substituted or unsubstituted aromatic or hetero-aromatic rings or fused or otherwise conjugated derivatives thereof. Examples of such aromatic or heteroaromatic rings include phenyl, pyridinyl, napthyl and phenanthracenyl.

Preferably, at least one of Ar¹, Ar² or Ar³ is substituted by alkyl, alkoxy, ether, halo alkyl, amino alkyl, aryl or heteroaryl, where any alkyl group is a straight or branched chain of 1-10 carbon atoms, preferably 1-8 carbon atoms, more preferably a straight or branched chain having 1, 2, 3, 4, 5, 6, 7, 8, 9 or 10 carbon atoms. In a particularly preferred embodiment, at least one of Ar¹, Ar² or Ar³ is twice substituted with a straight or branched alkyl chain of 1-10 carbon atoms, for example a straight or branched alkyl chain or 6, 7, 8, or 9 carbon atoms. The aryl group preferably contains from 3 to 12 carbon atoms, more preferably 6 to 12 carbon atoms. The heteroaryl group is preferably a 3 to 12 membered ring, more preferably a 5 to 12 membered ring containing 1 to 3 heteroatoms selected from N, S or O. Alkyoxy, ether and aminoalkyl groups all comprise an alkyl group as described above, said alkyl groups being substituted with or interrupted by 1 to 3 oxygen atoms or amino groups respectively. The haloalkyl group comprises an alkyl group as described above, substituted with 1 to 3 halo groups selected from F, Cl, Br or I.

Preferably, at least one of Ar¹, Ar² or Ar³ is substituted in the ortho- or para-position by an alkoxy group, most preferably in the para-position. Suitably, the alkoxy group is a short chain alkoxy group, for example containing 1, 2, 3 or 4 carbon atoms, most preferably methoxy. Although not wishing to be bound by any theory, it is thought that the presence of a short chain alkoxy group in the para-position increases the ease of oxidation of the material, thus facilitating hole conduction.

In a more preferred feature of the first aspect, [Y] may be a moiety represented by the general formula (III)

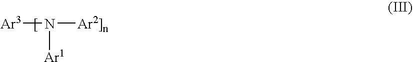

wherein n is 1 to 10, and wherein each Ar¹, Ar² or Ar³ may be the same or different and may be independently substituted with one or more substitutents as previously described.

For the purposes of the present invention, at least one of Ar¹, Ar² or Ar³ is preferably selected from structures (i) to (xii)

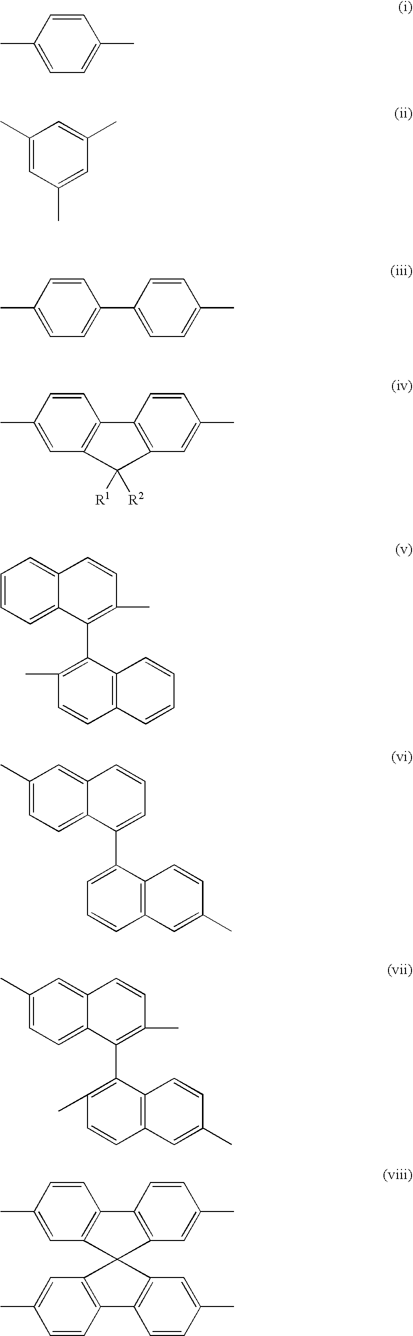

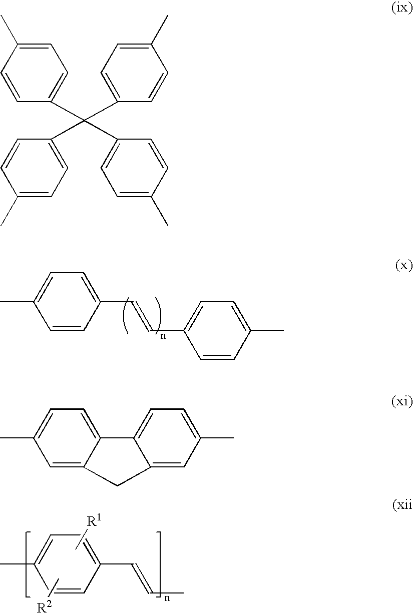

wherein R¹ and R² are independently selected from, hydrogen, halogen, C₁₋₁₀ akyl, C₁₋₁₀ alkoxy, C₁₋₁₀ ether, aminoC₁₋₁₀ alkyl, C₆₋₁₂ aryl or C₅₋₁₂ heteroaryl, in which any alkyl group is straight or branched chain of 1 to 10 carbon atoms; wherein n is an integer, preferably an integer of from 1 to 10; and wherein any of (i) to (xii) may be substituted or unsubstituted.

These materials exhibit high conductivities due to the presence of an extended conjugated structure. Preferably, the material exhibits extended π or mixed π-lone pair conjugation. This may be for example, by way of Ar—N—Ar type linkages, where the Ar groupings may themselves comprise extended conjugation through the connection of aromatic ring moieties with unsaturated groups.

Alternatively, [Y] may comprises other organic materials which provide both electronic charge transport properties and can be derivatised to include ion-chelating groups. Some non-limiting examples include poly(1,4-phenylene), polypyrrole, poly(p-phenylenevinylene) (PPV), poly(thiophene), MEH-PPV, polyaniline and PEDOT.

The X group is covalently attached to the group [Y] at any convenient position. It will be appreciated that each of Ar¹, Ar² or Ar³ may provide one or more X groups, said X groups being the same or different. Preferably, X is an ion-chelating agent comprising the repeat unit [—OCH₂CH₂—] or [—CH₂—]. Preferably X comprises at least one group selected from: [—(CH₂CH₂O)ₙCH₂CH₂OCH₃], [—(OCH₂CH₂)ₙOCH₃), [—(CH₂CH(R)O)ₙCH₂CH₂OCH₃] and [—(OCH(R)CH₂)ₙOCH₃]; wherein n is an integer, preferably 2 to 10, more preferably 2 to 4; wherein R is straight or branched alkyl chain of 1 to 10 carbon atoms, preferably of 1 or 2 carbon atoms.

The above ion-chelating groups are based on the repeat unit [—OCH₂CH₂—]. Side chain branching and/or the inclusion of [—OCH₂O—] repeat units, are advantageous to inhibit crystallisation after metal ion complexation. The groups contain preferably 3 or more [—OCH₂CH₂—] units and most preferably 3 units terminating in OR′ (R′=alkyl of up to 10 carbon atoms, e.g. methyl) containing 4 oxygen atoms for ion-chelation. Other ion-chelating groups may be made according to the specific need for ion binding, some examples including crown ethers, podands, lariat ethers, cryptands and spherands.

Although not as effective, a group with the structure of an ion-chelating group may be used as a linking group between moieties of general formula (II). If such a group is used it should be in the ortho- or para-position and not in the meta-position. Most preferably if such a linking group is used, it is in the para-position.

Suitably, the at least one ionic species is chosen from: Li⁺, Na⁺, K⁺, Cs⁺, Mg²⁺, Ca²⁺ or any other suitable ions. These may be provided for example, from triflimide, halides, perchlorates, trilates and BARF salts of the above cations.

In an embodiment of the present invention, the conducting material comprises an ohmic conductor. Suitable are metals such as gold, aluminium, copper, platinum, silver and calcium, non-metals such as graphite, highly-doped semiconductors such as ITO, fluorine-doped tin oxide, aluminium-doped zinc oxide and organic conductors such as PEDOT-PSS and polyaniline.

In an alternative embodiment, the conducting material comprises a semiconducting material. Suitable are TiO₂, ZnO, SnO, Ta₂O₅, Nb₂O₅, WO₃, OMeTAD, PPV, Cu-phthalocyanin, oligo- or polythiophenes, polypyrroles, TPDs, pentacene and perylenes.

In a further alternative embodiment, the conducting material comprises an ionic conductor. Suitable are polymer electrolytes such as PEO, co-polymers comprising PEO for example, poly-epichlorohydrin-co-ethyleneoxide and polymers supporting redox active species such as Ru(II)/(III) and Co(II)/(III). C₆₀ and its derivatives may also be suitable.

The semiconductor may be an inorganic semiconductor such as TiO₂, ZnO, SnO, Ta₂O₅, Nb₂O₅, WO₃ or an organic semiconductor such OMeTAD, PPV, Cu-phthalocyanin, oligo- or polythiophenes, polypyrroles, TPDs, pentacene and perylenes. In a preferred embodiment, the semiconductor is a nano-crystalline metal oxide for example, a nano-crystalline titania film which may be sensitised. Suitable sensitisers include dyes based on ruthenium bipyridyl complexes or organic dyes such as coumarins.

The semiconductor may be porous, in which case preferably, the dual-function material is at least partially contained within the pores of the semiconductor. This maximises the surface area of the semiconductor that is in contact with the dual-function material

The composite structures of the present invention are particularly suitable for inclusion in electrochemical devices and thus in accordance with a second aspect of the present invention, an electrochemical device comprises an composite structure and one further, or two ohmic conductors such that the device is provided with two external ohmic conductors. Dependent on the design of a particular device, the ohmic conductors may be arranged such that they are in direct contact with the outer surfaces of the composite structure or there may be one or more additional intervening layers.

Preferably, the ohmic conductors comprise metallic conductors such as gold, aluminium, copper, platinum, silver and calcium, or non-metallic conductors such as graphite, highly-doped semiconductors such as ITO, fluorine-doped tin oxide, aluminium-doped zinc oxide or organic conductors such as PEDOT-PSS and polyaniline Both ohmic conductors may be the same or different.

The composite structure of the present invention may be incorporated into a photo-voltaic cell however, its use is not limited thereto. Other potential applications will be known to those skilled in the art and include photodiodes, batteries, electrodes, electrochromic devices and light-emitting diodes.

All preferred features of each of the aspects of the invention apply to all other aspects mutatis mutandis.

The invention may be put into practice in various ways and a number of specific embodiments will be described by way of example to illustrate the invention with reference to the accompanying drawings, in which:

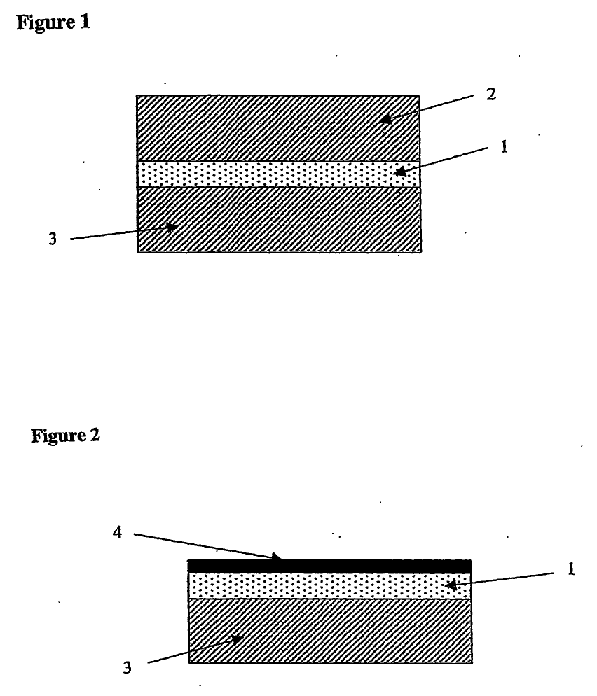

FIG. 1 is a schematic diagram of an example of a composite structure according to the present invention;

FIG. 2 is a schematic diagram of a further example of a composite structure according to the present invention;

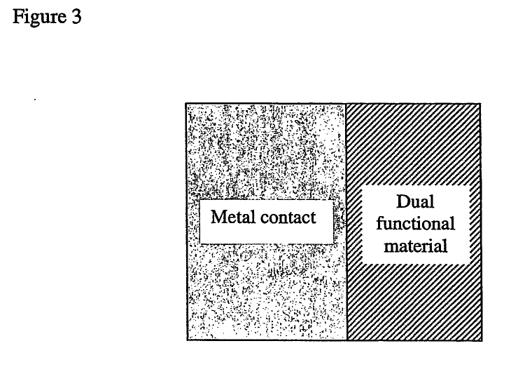

FIG. 3 is a schematic diagram of a further example of a composite structure according to the present invention;

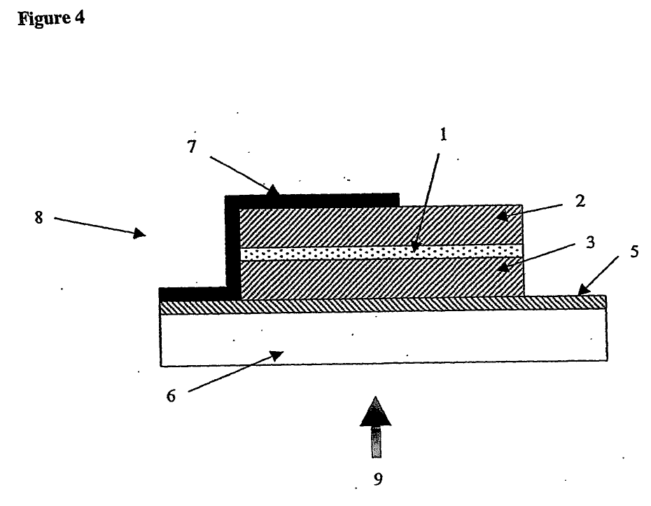

FIG. 4 is a schematic diagram of a photo-voltaic cell incorporating a composite structure according to the present invention;

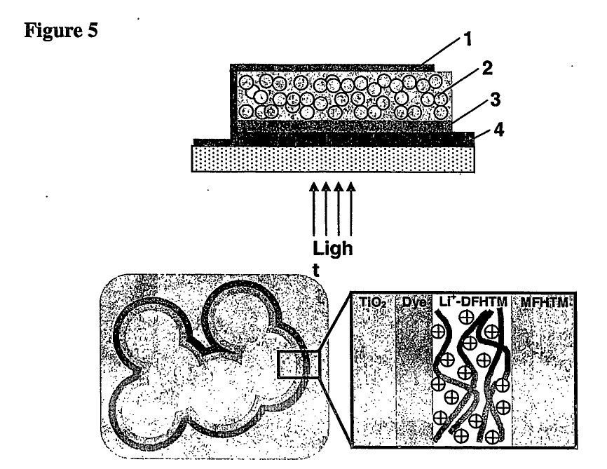

FIG. 5 is a schematic of the photovoltaic device based upon structure shown in FIG. 1. The device is based upon a multicomponent nanocomposite film (2) sandwiched between two electrodes: gold (1) and a dense TiO₂ blocking layer (3) on F—SnO₂ conducting glass (4). The multicomponent film comprises four structurally ordered phases: Ru(L)₂(NCS)₂ sensitised nanocrystalline mesoporous TiO₂ film/a Li⁺DFHTM. (⁻NTf₂) interface layer and a MFHTM interpenetrated into the film pores.

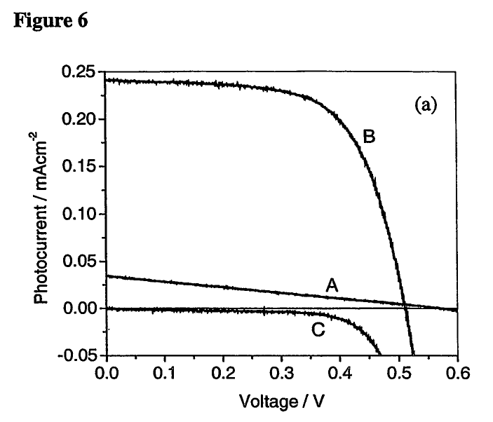

FIG. 6 shows photocurrent—voltage characteristics for photovoltaic devices based upon Ru(L)₂(NCS)₂ sensitised TiO₂/DFHTM/MFHTM photoactive layers obtained under 10 mWcm⁻² AM 1.5 solar illumination. Traces A and B show data in the absence (Trace A) and presence of (Trace B) of Li⁺(⁻NTf₂) ions in the DFHTM, as for FIG. 4. Trace C shows the corresponding dark data for case B.

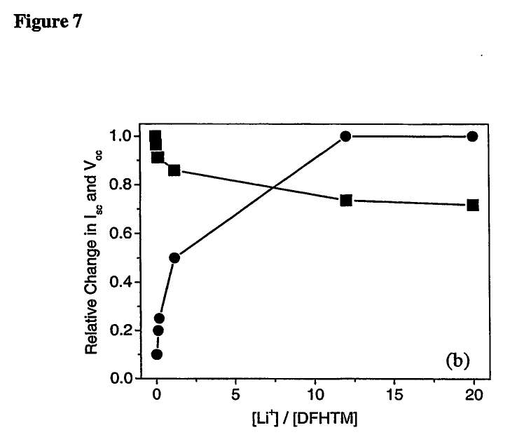

FIG. 7 shows the influence of dipping in variable lithium ion concentrations in DF-FM upon the short circuit current (●) and open circuit voltage (▪). The I/V data shown in FIG. 5, trace B were obtained with a Li⁺/DFHTM ratio of 12, yielding a device efficiency of 0.8%. Data were obtained with a non-scattering TiO₂ film, and without the addition of any additives to the MFHTM (spiro-OMeTAD) layer.

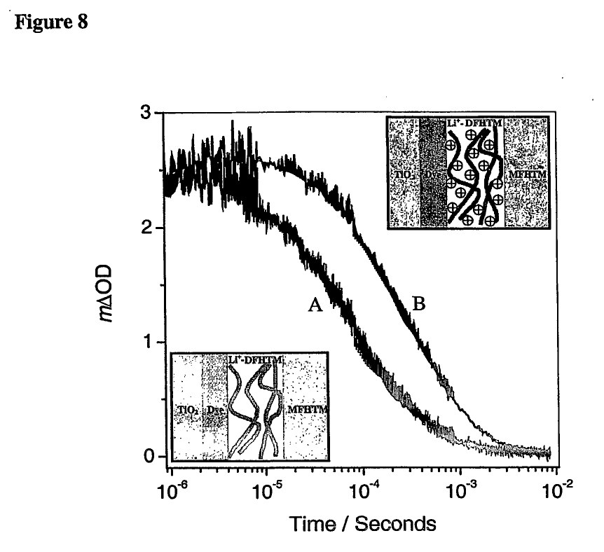

FIG. 8 shows transient absorption data obtained for samples Ru(L)₂(NCS)₂ sensitised TiO₂/DFHTM/MFHTM films in the absence (A) and presence (B) of Li⁺(⁻NTf₂) in the DFHTM layer. The decay kinetics are assigned to the charge recombination of the DFHTM cations with the electrons in the trap/conduction band states in the TiO₂ semiconductor. Lithium ion doping achieved by the addition of 12 M Li⁺(⁻NTf₂) to the DFHTM dipping solution.

With reference to FIG. 1, a composite structure comprises a dual-function material 1 intermediate an electron-transporting semiconductor 2 and a hole-conducting semiconductor 3. In the alternative embodiment of FIG. 2, the electron-transporting semiconductor is replaced with a metal layer 4.

The present invention will now be illustrated by reference to one or more of the following non-limiting examples.

### EXAMPLE 1

Fabrication of a Dye Sensitised Photo-Voltaic Cell.

With reference to FIG. 3, a dye sensitised nanocrystalline TiO₂ film 3 was prepared on a glass substrate 6 using the following procedure. The glass substrate was provided with a conducting coating of fluorine-doped tin oxide 5. A TiO₂ paste, consisting of ca. 15 nm sized particles (as determined by HRTEM) was prepared from a sol-gel colloidal suspension containing TiO₂ particles (12.5 wt %) and Carbowax™ 20,000 (6.2 wt %). The titania particles were produced by injecting titanium iso-propoxide (20 ml) into glacial acetic acid (5.5 g) under an atmosphere of argon followed by stirring for 10 minutes. The mixture was then injected into 0.1M nitric acid (120 ml) under an anhydrous atmosphere at room temperature and stirred vigorously. The resultant solution was left uncovered and heated at 80° C. for 8 hours. After cooling, the solution was filtered using a 0.45 μm syringe filter, diluted to 5 wt % TiO₂ by the addition of water and then heated in an autoclave at 220° C. for 12 hours. The resultant colloid was re-dispersed with a 60 second cycle burst from a LDU Soniprobe horn and then concentrated to 12.5% by rotary evaporation. Carbowax™ 20,000 was added and the resulting paste was stirred slowly overnight to ensure homogeneity. The paste was spread onto the glass substrate with a glass rod, using adhesive tape as a spacer. The film was dried in air and then sintered at 450° C. for 20 minutes, also in air. The thickness of the TiO₂ film was ca. 3 μm. The TiO₂ film was sensitized by immersing it in a 1 mM solution of a RuL₂(NCS)₂ dye in 1:1 acetonitrile/tert-butanol. Rinsing in ethanol removed any unadsorbed dye. Prior to use, samples were stored in dry glove box in the dark

A layer of a dual function material 1 was then deposited as follows. A solution was prepared by dissolving polymer A (structure below) and lithium triflimide, at a mole ratio of 1:12, in a chlorobenzene/acetonitrile solvent mixture (1:9 volume ratio).

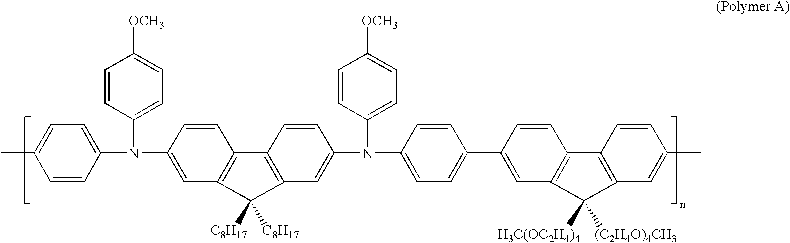

The dye sensitised TiO₂ film as prepared above was immersed in the polymer A solution for 2 hours at a temperature of 70 ° C. The immersion time and temperature provide a control of the ion/polymer concentration at the interface. This step resulted in the conformal deposition of a layer of the dual function material on the surface of the dye sensitised, nanocrystalline TiO₂ film.

A hole-transporting semiconducting layer 2 of a spiro-OMeTAD material (structure B below) was then deposited onto the layer of dual-function material by spin coating from solvent solution (0.2M solution in chlorobenzene for 60 seconds). This solution did not contain any added ionic species, chemical dopants or ion-solvating species. The resulting sample was left under vacuum for 2 hours and then transferred to a thermal evaporator. A gold contact 7 was deposited under a pressure of ca. 1-2×10⁻⁶ atm. This provided a photo-voltaic cell 8 incorporating an composite structure according to the invention. For comparative purposes, a second device (not shown) was prepared omitting the layer of dual-function material.

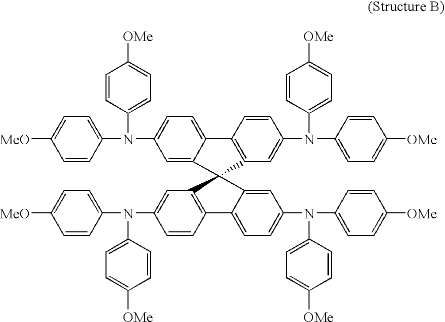

### EXAMPLE 2

Cell Testing

Both devices prepared in Example 1 had a cell area of 0.2 cm² and were exposed to 10 mWcm⁻² of simulated AM1.5 solar irradiation during data collection, as indicated by arrow 9. As shown in FIG. 4, the current—voltage characteristics of the device according to the invention (curve 10) showed an efficient photovoltaic response. By contrast, the device absent the layer of dual-function material (curve 11) showed a negligible photovoltaic response.

The specific ordering of the layers in the device was found to be important. Surprisingly, reversing the order of the dual-function material (polymer A) and the hole-transporting semiconducting layer (structure B), produced a device which showed only a very poor photovoltaic response. This observation indicates that the dual-function material should be inserted at the interface of the dye-sensitised titania layer with the hole-transporting semiconducting layer. Although not wishing to be bound by any theory, it is thought to be advantageous that the dual-function material be present as a thin layer at the interface.

1. A composite structure comprising:
a dual-function material intermediate a conducting material and a semiconductor;
wherein the conducting material comprises at least one of an ohmic conductor, a semiconducting material and an ionic conductors; and
wherein the dual-function material comprises an organic material and at least one ionic species, said organic material comprising at least one moiety represented by the general formula (I):
[Y]—X (I)
wherein [Y] comprises an organic semiconductor; and wherein X comprises an ion-chelating group, said organic material having both electronic charge transport properties and supporting or chelating the at least one ionic species.

2. The structure of claim 1, wherein [Y] comprises a moiety represented by the general formula (II): 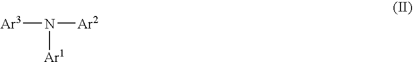
wherein Ar¹, Ar² and Ar³ are independently substituted or unsubstituted aromatic or hetero-aromatic rings or fused or conjugated derivatives thereof.

3. The structure of claim 1, wherein [Y] comprises at least one of poly(1,4-phenylene), polypyrrole, poly(p-phenylenevinylene) (PPV), poly(thiophene), MEH-PPV, polyaniline and PEDOT.

4. The structure of claim 1, wherein X comprises at least one of: [—(CH₂CH₂O)ₙCH₂CH₂OCH₃], [—(OCH₂CH₂)ₙOCH₃], [—(CH₂CH(R)O)ₙCH₂CH₂OCH₃] and [—(OCH(R)CH₂)ₙOCH₃]; wherein n is an integer of 2 to 10; wherein R is straight or branched alkyl chain of 1 to 10 carbon atoms.

5. The structure of claim 4, wherein X comprises at least one of a crown ether, a podand, a lariat ether, a cryptand and a spherand.

6. The structure of claim 1, wherein the at least one ionic species is selected from the group consisting of: Li⁺, Na⁺, K⁺, Cs⁺, Mg²⁺, Ca²⁺ , triflimide, halide, perchlorate, trilate and BARF salts of Li⁺, Na⁺, K⁺, Cs⁺, Mg²⁺, Ca²⁺.

7. The structure of claim 1, wherein the conducting material comprises an ohmic conductor and is at least one of: a metal, graphite, a highly-doped semiconductor and an organic conductor.

8. The structure of claim 1, wherein the conducting material comprises a semiconducting material being at least one of: TiO₂, ZnO, SnO, Ta₂O₅, Nb₂O₅, WO₃, OMeTAD, PPV, Cu-phthalocyanin, polythiophenes, polypyrroles, pentacene and perylenes.

9. The structure of claim 1, wherein the conducting material comprises an ionic conductor and is at least one of: a polymer electrolyte, and a polymer supporting a redox active species.

10. The structure of claim 1, wherein the semiconductor is at least one of: TiO₂, ZnO, SnO, Ta₂O₅, Nb₂O₅, WO₃, OMeTAD, PPV, Cu-phthalocyanin, oligothiophenes, polythiophenes, polypyrroles, TPDs, pentacene and perylenes.

11. The structure of claim 1, wherein the semiconductor is porous and the dual-function material is at least partially contained within the pores of the semiconductor.

12. An electrochemical device, comprising:
a structure including a dual-function material intermediate a conducting material and a semiconductor;
wherein the conducting material comprises at least one of an ohmic conductor, a semiconducting material and an ionic conductor; and
wherein the dual-function material comprises an organic material and at least one ionic species, said organic material comprising at least one moiety represented by the general formula (I):
[Y]—X (I)
wherein [Y] comprises an organic semiconductor; and wherein X comprises an ion-chelating group, said organic material having both electronic charge transport properties and supporting or chelating the at least one ionic species; and
at least two external ohmic conductors in electrical communication with the structure.

13. A photo-voltaic cell comprising:
a structure including a dual-function material intermediate a conducting material and a semiconductor;
wherein the conducting material comprises at least one of an ohmic conductor, a semiconducting material and an ionic conductor; and
wherein the dual-function material comprises an organic material and at least one ionic species, said organic material comprising at least one moiety represented by the general formula (I):
[Y]—X (I)
wherein [Y] comprises an organic semiconductor; and wherein X comprises an ion-chelating group, said organic material having both electronic charge transport properties and supporting or chelating the at least one ionic species.

14. The device of claim 12 wherein the structure and at least two ohmic conductors are included in at least one of a photodiode, a battery, an electrode, an electrochromic device and a light-emitting diode.
